(19) United States
(12) Patent Application Publication
(10) Pub. No.: US 2008/0043665 A1
(43) Pub. Date: Feb. 21, 2008

(54) IPv6 NEIGHBOR DISCOVERY SUPPORT METHOD ON WIRELESS COMMUNICATIONS SYSTEM

(76) Inventors: Hong-Seok JEON, Daejeon-city (KR); Jung-Hoon JEE, Daejeon-city (KR); Eun-Ah KIM, Daejeon-city (KR); Hee-Young JUNG, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/739,282

(22) Filed: Apr. 24, 2007

(30) Foreign Application Priority Data
Aug. 18, 2006 (KR) 10-2006-0078289
Dec. 8, 2006 (KR) 10-2006-0124894

(51) Int. Cl. H04Q 7/20

(52) U.S. Cl. 370/328; 455/436; 455/466

(57) ABSTRACT

The present invention relates to method supporting an IPv6 neighbor discovery in an IEEE 802.16 based wireless communication system. More specifically, the invention relates to an IPv6 (Internet Protocol version 6) neighbor discovery support method in a wireless communication system where all attached subscriber stations share a common network prefix, particularly, in an IEEE 802.16 network using Ethernet CS (convergence sublayer) network. According to the above-described method, a base station manages information on subscriber stations to which the base station provides a service on the basis of an Identification Cache Table (ICT), and performs a process of controlling unnecessary transmission of IPv6 neighbor discovery messages and an IPv6 neighbor discovery proxy function on the basis of the information on the subscriber station. According to the present invention, as the base station controls transmission of the IPv6 neighbor discovery messages in the wireless communication system where the common network prefix is allocated, it is possible to reduce waste of radio resource and power consumption of the subscriber stations.

### CROSS-REFERENCE TO RELATED APPLICATION

This application claims priority to and the benefit of Korean Patent Application No.10-2006-0078289 and 10-2006-0124894 respectively filed in the Korean Intellectual Property Office on Aug. 18 and Dec. 08, 2006, the entire contents of which are incorporated herein by reference.

### BACKGROUND OF THE INVENTION

(a) Field of the Invention

The present invention relates to an IPv6 (Internet Protocol version 6) neighbor discovery support method in a wireless communication system. More specifically, the invention relates to a method supporting an IPv6 neighbor discovery in a wireless communication system where all attached subscriber stations share a common network prefix, particularly in an IEEE 802.16 based wireless communication system using Ethernet CS (Convergence Sublayer).

(b) Description of the Related Art

A CS (Convergence Sublayer) is a sublayer that belongs to a MAC layer of IEEE 802.16. It maps data of an upper layer to an IEEE 802.16 MAC header. Although several CSs are introduced in the IEEE.802.16 standard, the CSs may be divided into Ethernet CSs considering Ethernet data as data of an upper layer and IP CSs considering IP data as data of an upper layer because other CSs are not likely to be used.

IPv6 neighbor discovery defines operations between IPv6 nodes that exist on the same link in an IPv6 network [RFC2461]. Among messages that are used for the IPv6 neighbor discovery, a router advertisement (RA) message and a neighbor advertisement (NA) message may have an all-nodes multicast address as their destination addresses. The IPv6 neighbor discovery messages destined for the all-nodes multicast address are transmitted to all subscriber stations, which causes subscriber stations in an energy saving mode to wake up and results in power consumption of the subscriber stations.

Further, an IEEE 802.16 network basically features a point-to-multipoint connection. FIG. 1 is a schematic diagram which depicts a basic point-to-multipoint connection in an IEEE 802.16 based network.

Referring to FIG. 1, IEEE 802.16 based network providing the point-to-multipoint connection includes an ISP network 10, an access router 11, a base station 12, and subscriber stations 13. All of the subscriber stations 13 are connected to the base station 12 and, even when the subscriber stations connected to the same base station 12 have been configured with a same prefix, the subscriber stations cannot directly communicate with each other at link layer. In such a point-to-multipoint network, multicast support of a link region like an Ethernet environment is fundamentally impossible. That is, while an IPv6 neighbor discovery protocol assumes multicast transmission in a lower link technique, the IEEE 802.16 based networks do not support the multicast transmission on IP data.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of solving problems such as waste of radio resources and power consumption of subscriber stations occurring when IPv6 neighbor discovery is performed in a state that all subscriber stations existing under a same access router AR in a wireless communication system have common network prefix information.

Further, the present invention has been made in an effort to provide multicast transmission support of IP data in an IEEE 802.16 based network.

More specifically, the invention provides a method in which a base station manages information on subscriber stations to which the base station provides a service on the basis of an identification cache table (hereinafter referred to as an “ICT”), and performs a process of controlling unnecessary transmission of IPv6 neighbor discovery messages and an IPv6 neighbor discovery proxy function on the basis of the ICT.

An exemplary embodiment of the present invention provides an IPv6 neighbor discovery support method by a base station in a wireless communication system where a common network prefix is allocated. The method includes receiving a neighbor solicitation (NS) message sent from a Request Subscriber Station (Request SS), which is a sender of IPv6 Neighbor Discovery messages, to resolve a MAC address of a Target Subscriber Station (Target SS), which is an intended recipient of the IPv6 Neighbor Discovery messages, determining whether or not a base station is a Target Base Station (Target BS), which is a base station serving the Target SS, with reference to an Identification Cache Table (ICT) (i.e., a table including subscriber stations' MAC addresses, and subscriber stations' IP addresses and their valid flag information), causing the Target BS instead of the Target SS to respond to the NS message with a neighbor advertisement (NA) message when the base station is determined as the Target BS, causing the Request Base Station (Request BS), which is a base station serving the Request SS, to receive the NA message from the Target BS, and causing the Request BS to transmit the NA message to the Request SS.

Another embodiment of the present invention provides an IPv6 neighbor discovery support method by base stations in a wireless communication system where a common network prefix is allocated. The method includes causing a Request BS to receive a neighbor solicitation (NS) message that is sent from a Request SS for Duplicate Address Detection (DAD) on an IPv6 address generated by the Request SS, updating an Identification Cache Table (ICT) on the basis of the NS message received by the Request BS, causing the Request BS to transmit the NS message to the network, determining whether or not base stations that receive the NS message through the network is a Target BS, causing the Target BS instead of the Target SS to respond to the NS message with a neighbor advertisement (NA) message for duplicate address detection (DAD) when the base station is determined as the Target BS, causing the Request BS to receive the NA message from the Target BS, and causing the Request BS to transmit the NA message to the Request SS.

Another embodiment of the present invention provides a method of transmitting a router advertisement (RA) message, which has an all-nodes multicast address as a destination address, by a base station in a wireless communication system to which a common network prefix is allocated. The method includes receiving the RA message from the access router and transmitting the RA message by using a Common CID (CCID).

Another embodiment of the present invention provides a method of transmitting a neighbor solicitation (NS) message, which has a solicited-node address as a destination address, by a base station in a wireless communication system to which a common network prefix is allocated. The method includes receiving the NS message and transmitting the NS message by a multi-unicast transmission method.

### BRIEF DESCRIPTION OF THE DRAWINGS

FIG. 1 is a schematic diagram illustrating a point-to-multipoint connection in a general wireless communication system.

FIG. 2 is a flowchart illustrating a method of generating information of an Identification Cache Table (ICT) in a wireless communication system according to an exemplary embodiment of the present invention.

FIG. 3 is a schematic diagram illustrating a wireless communication system according to an exemplary embodiment of the present invention.

FIG. 4 is a schematic diagram illustrating a system transmitting data that has an all-nodes multicast address as a destination address by using a CCID according to an exemplary embodiment of the present invention.

FIG. 5 is a flowchart illustrating a method transmitting data that has a solicited-node address as a destination address by using multi-unicast according to an exemplary embodiment of the present invention.

FIG. 6 is a flowchart illustrating a support method when a neighbor solicitation (NS) message is sent to resolve MAC address of a subscriber station, according to an exemplary embodiment of the present invention.

FIG. 7 is a flowchart illustrating a case in which a network permits a proxy function of a base station during Duplicate Address Detection according to an exemplary embodiment of the present invention.

FIG. 8 is a flowchart illustrating a case in which a network does not permit a proxy function of a base station during Duplicate Address Detection according to an exemplary embodiment of the present invention.

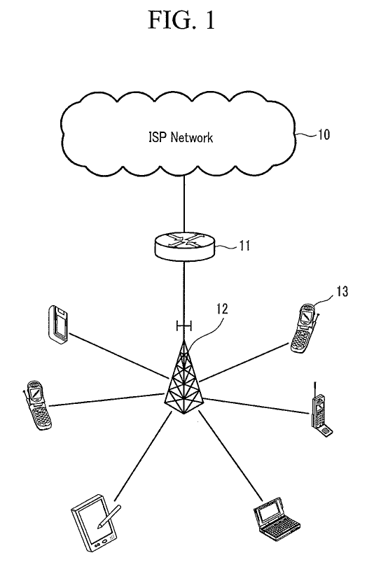

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

An IPv6 neighbor discovery support method in a wireless communication system where all attached subscriber stations share a common network prefix according to an exemplary embodiment of the present invention will now be described in detail with reference to the accompanying drawings.

In the embodiment of the present invention, each base stations form Identification Cache Tables (ICTs) thereof, and perform a process of controlling unnecessary transmission of IPv6 neighbor discovery messages and an IPv6 neighbor discovery proxy function. More specifically, the ICT located in each of the base stations basically includes MAC addresses of the subscriber stations, and at least one IPv6 address and its valid flag information on whether each IPv6 address is valid or not.

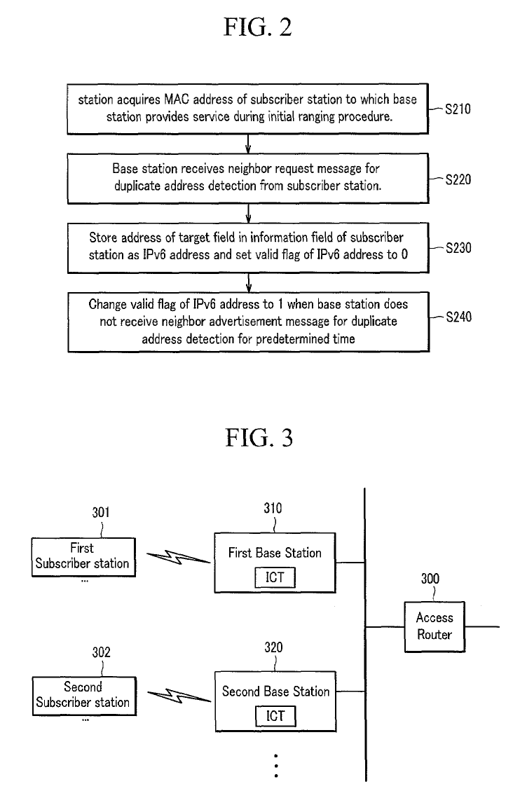

FIG. 2 is a flowchart illustrating a method of generating ICT information according to an exemplary embodiment of the present invention.

A base station acquires MAC addresses of subscriber stations to which the base station provides a service during an initial ranging procedure that is defined in an IEEE 802.16 based wireless communication system and creates new entries for the subscriber stations in its ICT (S210).

Once a subscriber station generates a link-local unicast address and a global unicast address according to RFC2462, a base station (i.e. Request BS) serving the subscriber stations receives a neighbor solicitation (NS) message sent from the subscriber stations (i.e. Request SSs) for the purpose of Duplicate Address Detection (DAD) on the generated addresses (S220). The NS message for DAD includes the generated addresses in a target address field. When receiving the NS for the DAD from the Request SSs, the Request BS stores the address specified in the target address field of the NS message in its ICT as an IPv6 address field of the corresponding subscriber station, and sets a valid flag of the corresponding IPv6 address to 0 (S230). Here, the valid flag being set to 0 means that validity of the corresponding IPv6 address is not yet confirmed.

After relaying the NS message for the DAD to network, if the Request BS does not receive a neighbor advertisement (NA) message as a reply to the NS message since a predetermined time (one second, and this set value may be changed according to a structure of the network) is elapsed, the base station changes the valid flag of the IPv6 address to 1 (S240). This means that uniqueness of the IPv6 address is verified, and the IPv6 address information is managed as the IPv6 address of the terminals.

Next, a method of supporting an IPv6 neighbor discovery by using ICT information according to an exemplary embodiment of the present invention will be described.

First, a structure of an IEEE 802.16 network using Ethernet CS to which the present invention is applied will be described with reference to FIG. 3.

FIG. 3 is a schematic diagram illustrating a wireless communication system according to an exemplary embodiment of the present invention.

As shown in FIG. 3, the wireless communication system includes an access router 300 connected to a network, a first base station 310, a second base station 320, a first subscriber station 301 connected to the first base station 310, and a second subscriber station 302 connected to the second base station 320. In FIG. 3, the subscriber stations 301 and 302 are simply connected to the base stations 310 and 320 and the access router 300. However, the access router 300 may be connected to a plurality of base stations, and the plurality of base stations may include a plurality of subscriber stations, respectively. Alternatively, a more complicated structure is possible. In FIG. 3, one router manages a plurality of base stations. Further, the base stations 310 and 320 generate ICTs according to the above-described process and support an IPv6 neighbor discovery.

Meanwhile, the IPv6 neighbor discovery assumes multicast transmission support in a link layer as well as IP layer. However, the IEEE 802.16 technique does not support link layer multicast transmission mapped to IP layer multicast transmission.

Hence, when the IPv6 neighbor discovery procedure is performed in IEEE 802.16 based networks, a method supporting multicast transmission of IPv6 neighbor discovery messages is required.

Following describes the methods for multicast transmission of IPv6 neighbor discovery messages in the wireless communication system according to the exemplary embodiment of the present invention.

As a first method, there is provided a multicast transmission method that uses a Common Connection Identifier (CCID). This method aims to transmit IPv6 neighbor discovery messages that use an all-nodes multicast address as a destination address.

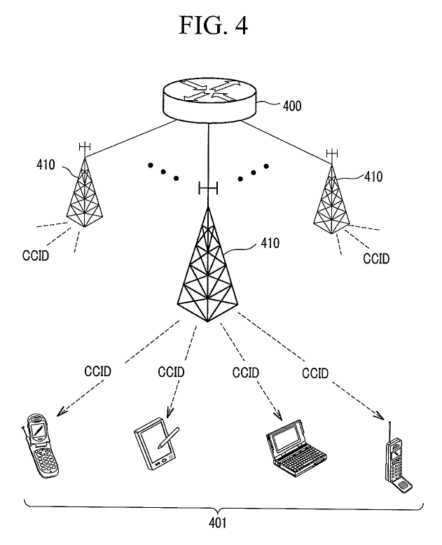

FIG. 4 is a schematic diagram illustrating a multicast system using the CCID according to an exemplary embodiment of the present invention.

As shown in FIG. 4, a base station 410 receives a router advertisement (RA) transmitted from a network 400. Then, the base station 410 transmits the RA message to all the subscriber stations 401 to which the base station 410 is providing a service, by using a CCID.

The CCID is one of Multicast and Broadcast Connection Identifier (MBS-CID) which is defined in IEEE 802.16e standard. While the MBS-CID is a CID that a base station commonly generates only for the subscriber stations that desire the same media contents, the CCID is a CID that is commonly generated for all the subscriber stations that are served by a same base station. All the subscriber stations receive data that the base station transmits by using the CCID. Therefore, when the base station transmits the IPv6 neighbor discovery messages that have the all-nodes multicast address as the destination address through its wireless interface thereof, the multicast transmission of the IPv6 neighbor discovery messages is performed by using the CCID. In order to generate the CCID, the base station and the subscriber stations conform to a process of generating an MBS-CID according to the IEEE 802.16e standard. Description thereof will be omitted.

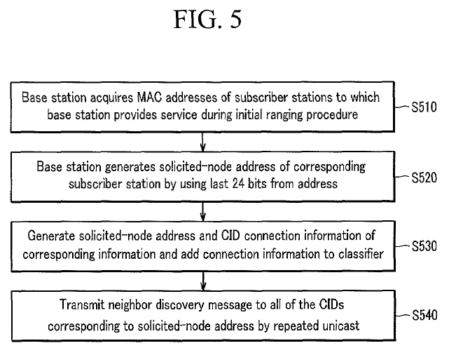

As a second method, there is provided an IP multicast data transmission method that uses multi-unicast transmission. This method intends to transmit IPv6 neighbor discovery messages that have a solicited-node address as a destination address. The multi-unicast transmission is a method in which a base station maintains information on subscriber stations to which the IPv6 neighbor discovery message needs to be transmitted and transmits the IPv6 neighbor discovery message to the subscriber stations by replicated unicast transmissions. A characteristic of the above-described method will be described with reference to FIG. 5.

FIG. 5 is a flowchart illustrating a multicast transmission method by using multi-unicast transmission according to an exemplary embodiment of the present invention.

As shown in FIG. 5, a base station acquires MAC address of a subscriber station during an initial ranging procedure that is defined in an IEEE 802.16 based wireless communication system (S510).

Next, the base station derives a solicited-node address corresponding to the subscriber station with the last 24 bits from the MAC address of the subscriber station according to RFC2373 (S520).

Next, the base station maintains relationship between the derived solicited-node address and a CID, which is assigned to the subscriber station. The relationship may be appended to a classifier that is referenced when the base station transmits data to the subscriber station (S530).

Next, when the base station transmits the IPv6 neighbor discovery message that has the solicited-node address as a destination address via its wireless interface, the base station refers to the classifier including the relationship thereof and transmits the IPv6 neighbor discovery message on each CIDs related to the solicited-node address by replicated unicast transmissions (S540).

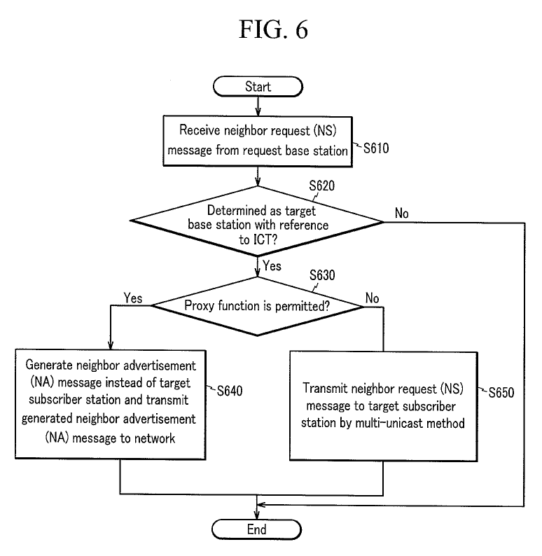

Meanwhile, FIGS. 6, 7, and 8 are flowcharts illustrating a process by which IPv6 neighbor discovery is supported in a wireless communication system.

FIG. 6 is a flowchart illustrating a method according to an exemplary embodiment of the present invention when a subscriber station (i.e. Request SS) sends a neighbor solicitation (NS) message in order to resolve a MAC address of another subscriber station existing in the same IP link.

What is illustrated in FIG. 6 is described with reference to the structure of FIG. 3. The Request SS 301 has finished an initial setup and an authentication process and has been configured with an IPv6 address. The Request SS 301 transmits a neighbor solicitation (NS) message in order to resolve a MAC address of the subscriber station 302 existing in the same IP link. The NS message is transmitted to the Request BS 310. The Request BS 310 transmits the NS message to a wired network (where different base stations and a different access router exist). Therefore, other base stations receive the NS message (S610). Each of the base stations having received the NS message checks whether IPv6 address specified in a target address field of the NS message is registered as an IPv6 address whose valid flag is set to 1 in an ICT of each the base stations. When the corresponding IPv6 address is already registered in the ICT, the base station becomes a Target BS (S620). Otherwise, the base stations are not a Target BS and ignore the NS message. When the above-described base station is the Target BS 320 providing a service to the Target SS 302 and the network permits a proxy function on the IPv6 neighbor discovery (S630), the Target BS 320 generates a neighbor advertisement (NA) message instead of the Target SS 302 by referring to an ICT, and then transmits the NA message to the network (S640). Meanwhile, when the network does not permit a proxy function on the IPv6 neighbor discovery, the Target BS 320 transmits the NS message to the Target SS by a multi-unicast method (S650).

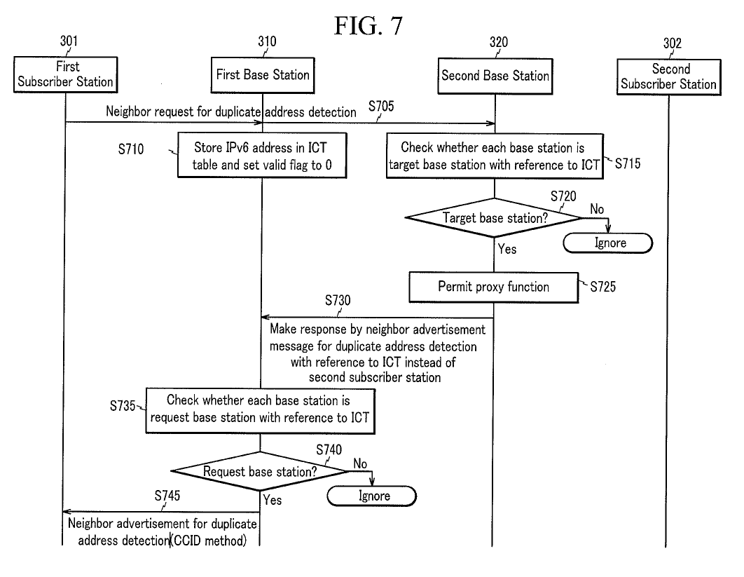

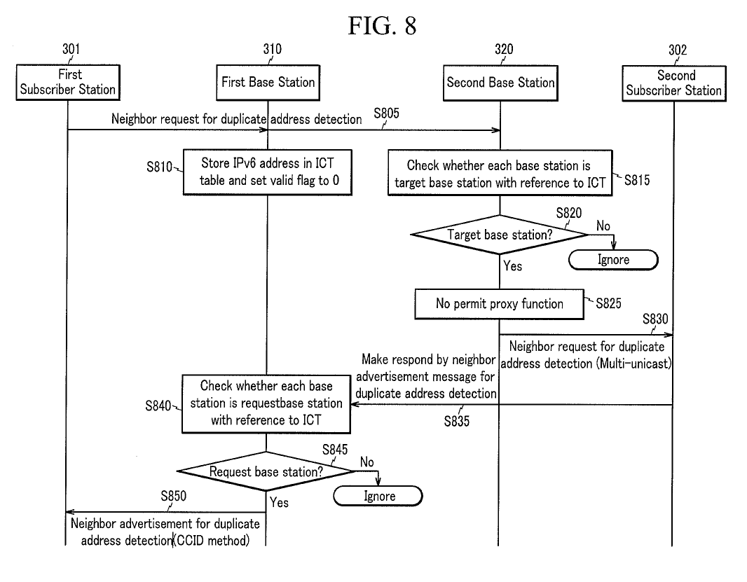

Meanwhile, FIGS. 7 and 8 are flowcharts illustrating methods according to another exemplary embodiment of the present invention when a subscriber station sends a neighbor solicitation (NS) message for Duplicate Address Detection (DAD) in case that a network permits a proxy function of IPv6 neighbor discovery and does not.

FIG. 7 is a flowchart illustrating a case in which a network permits a proxy function of IPv6 neighbor discovery during DAD according to an exemplary embodiment of the present invention.

What is described in FIG. 7 is described with reference to the structure of FIG. 3. The subscriber station (i.e. Request SS) 301 generates an IPv6 address thereof, and then sends a neighbor solicitation (NS) message for DAD in order to determine whether the generated address is unique or not (S705). At this time, after the Request BS 310 that is providing a service to the Request SS 301 receives the NS message for the DAD, the Request BS 310 stores information, which is specified in a target address field of the NS message, in its ICT as an IPv6 address of the Request SS 301, sets the corresponding valid flag to 0, and then transmits the NS message to the network (S710). Each of the base stations having received the NS message for the DAD checks whether the IPv6 address in the target address field of the NS message is registered in the ICT of each the base stations as an IPv6 address regardless of a set value of the valid flag (S715). If the corresponding IPv6 address is registered in the ICT, the base stations become Target BSs (S720). Otherwise, each of the base stations is not a Target BS and ignores the NS message for the DAD. If the above-described base station is the Target BS 320 that is providing a service to the Target SS 302 (S725), the Target BS 320 refers to the ICT and generates a neighbor advertisement (NA) message for DAD instead of the Target SS 302, and then transmits the NA message for the DAD to the network (S730). Each of the base stations having received the NA message for the DAD checks whether an IPv6 address in the target address field of the NA message is registered in its ICT as the IPv6 address whose valid flag is 0 (S735). When the corresponding IPv6 address is registered in the ICT, each of the base stations identifies itself as a Request BS (S740). Otherwise, each of the base stations is not a Request BS and ignores the NA message for the DAD. When the above-described base station is the Request BS 310 that provides a service to the Request SS 301, the Request BS 310 transmits the NA message for the DAD to the Request SS 301 by using a multicast transmission method using a CCID (S745).

FIG. 8 is a flowchart illustrating a case in which a network does not permit a proxy function of IPv6 neighbor discovery during DAD according to an exemplary embodiment of the present invention.

What is described in FIG. 8 is described with reference to the structure of FIG. 3. Steps S805 and S810 are the same as Steps S705 and S710 in FIG. 7, and description thereof will be omitted.

Each of the base stations receiving the NS message for the DAD determines whether an IPv6 address in the target address field of the NS message is registered in its ICT as the IPv6 address regardless of a set value of the valid flag (S815). When the corresponding IPv6 address is registered in the ICT, each of the base stations identifies itself as a Target BS (S820). Otherwise, each of the base stations is not a Target BS and ignores the NS message for the DAD. When the base station is the Target BS 320 that provides a service to the Target SS 302 (S825), the Target BS 320 transmits the NS message for the DAD to the Target SS 302 according to a multi-unicast method (S830). The Target SS 302 having received the NS message for the DAD makes a response by transmitting NA message for the DAD (S835).

Since Steps S840 to S850 of the Request BS for the NA message for the DAD are the same as Steps S735 to S745 of FIG. 7, descriptions thereof will be omitted.

As such, the present invention prevents base stations from transmitting of the unnecessary IPv6 neighbor discovery messages in the network where direct communication and multicast are not supported. It reduces waste of radio resources and power consumption of the subscriber stations.

As described above, according to the embodiment of the present invention, when the subscriber stations existing under a same access router have information on one common network prefix in the wireless communication system, unnecessary transmission of the IPv6 neighbor discovery messages is controlled in the base station. It reduces the waste of radio resources and power consumption of the subscriber stations. Further, in the wireless communication network, a method of a multicast service by defining multi-unicast and a CCID solves a problem in that the IP multicast service is not supported.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An IPv6 neighbor discovery support method by a base station in a wireless communication system where all attached subscriber stations share a common network prefix, the method comprising:
receiving a neighbor solicitation (NS) message that is transmitted from a Request SS to resolve a MAC address of a Target SS;
determining whether or not a base station is a Target BS that provides a service to the Target SS with reference to an Identification Cache Table (ICT) (i.e., a table including subscriber stations' MAC addresses, and subscriber stations' IP addresses and their valid flag information);
causing the Target BS instead of the Target SS to respond to the NS message with a neighbor advertisement (NA) message, when the base station is determined as the Target BS;
causing the Request BS to receive the NA message from the Target BS; and
causing the Request BS to transmit the NA message to the Request SS.

2. The method of claim 1, wherein the causing of the Target BS to transmit the neighbor advertisement (NA) message to the Request SS includes:
causing the Target BS to transmit the neighbor solicitation (NS) message to the Target SS when the network does not permit a proxy function of IPv6 neighbor discovery;
receiving the neighbor advertisement (NA) message from the Target SS; and
transmitting the received neighbor advertisement (NA) message to the Request SS through the Request BS.

3. The method of claim 2, wherein the causing of the Target BS to transmit the neighbor solicitation (NS) message to the Target SS includes:
transmitting the neighbor solicitation (NS) message to the Target SSs by a multi-unicast method that transmits the neighbor solicitation (NS) message by repeated unicast transmission through all the corresponding connection identifiers (CIDs).

4. The method of claim 3, wherein the multi-unicast method includes:
causing the base station to acquire a MAC address of the subscriber station served by the base station during an initial ranging procedure that is defined in IEEE 802.16;
deriving a solicited-node address corresponding to the subscriber station with the last 24 bits from the MAC address of the subscriber station;
maintaining relationship between the derived solicited-node address and a connection identifier (CID) assigned to the corresponding subscriber station; and
causing the base station to transmit a neighbor discovery messages destined for a solicited-node address with reference to the maintained relationship.

5. An IPv6 neighbor discovery support method by a base station in a wireless communication system where all attached subscriber stations share a common network prefix, the method comprising:
causing a Request BS to receive a neighbor solicitation (NS) message that is transmitted for duplicate address detection (DAD) on an IPv6 address generated by a Request SS;
updating an Identification Cache Table (ICT) (i.e., a table including subscriber stations' MAC addresses, and subscriber stations' IP addresses and their valid flag information) on the basis of the NS message for the DAD received from the Request SS;
causing the Request BS to transmit the NS message for the DAD to the network;
determining whether or not a base station that receives the NS message for the DAD through the network is a Target BS that provides a service to a Target SS;
causing the Target BS instead of the Target SS to respond the NS message with a neighbor advertisement (NA) message for DAD when the base station is determined as the Target BS;
causing the Request BS to receive the NA message for the DAD from the Target BS; and
causing the Request BS to transmit the NA message to the Request SS.

6. The method of claim 5, wherein the causing of the Target BS to transmit the neighbor advertisement (NA) message includes:
causing the base station to transmit the neighbor solicitation (NS) message to the Target SS when the network does not permit the proxy function of IPv6 neighbor discovery;
receiving a neighbor advertisement (NA) message from the Target SS; and
transmitting the received NA message to the Request SS through the Request BS.

7. The method of claim 6, wherein in the causing of the base station to transmit the neighbor solicitation (NS) message to the Target SS, the NS message is transmitted to the Target SS by a multi-unicast method that transmits the NS message by repeated unicast transmissions through all the corresponding connection identifiers (CIDs).

8. The method of claim 5, wherein the causing of the Request BS to receive the neighbor advertisement (NA) message includes:
causing base stations that receive the neighbor advertisement (NA) message for duplicate address detection (DAD) to determine whether an IPv6 address in a target address field of the message is registered in an ICT of each of the base stations as an IPv6 address whose valid flag is set to 0;
determining, if the corresponding IPv6 address is registered in the ICT, that each of the base stations is a Request BS; and
determining, if the corresponding IPv6 address is not registered in the ICT, that each of the base stations is not a Request BS, and ignoring the NA message for the DAD.

9. The method of claim 5, wherein in the causing of the Request BS to transmit the neighbor advertisement (NA) message to the Request SS, the NA message that has an all-nodes multicast address as a destination address is transmitted to the Request SS by a common connection identifier (CCID) method.

10. The method of claim 9, wherein the common connection identifier (CCID) method allows all the subscriber stations served by the same base station to receive data being transmitted by using a connection identifier (CID) that is commonly generated for all the subscriber stations.

11. The method of claim 1, wherein before the receiving of the neighbor solicitation (NS) message that is transmitted from the Request SS through the Request BS so as to resolve the MAC address of the Target SS, a method of generating the Identification Cash Table (ICT) includes:
causing a base station to acquire a MAC address of a subscriber station served by the base station during an initial ranging procedure defined in the IEEE 802.16 based wireless communication system;
causing, when receiving a neighbor solicitation (NS) message for Duplicate Address Detection (DAD) from the subscriber station to which the base station provides a service, the base station to store an address of a target address field of the NS message in an information field of the corresponding subscriber station as an IPv6 address, and set a valid flag of the corresponding IPv6 address to 0; and
changing the valid flag of the IPv6 address to 1 and storing the changed valid flag in the Identification Cache Table (ICT) when the Request BS does not receive a neighbor advertisement (NA) message corresponding to the NS message for a predetermined time after relaying the NS message for the DAD to network.

12. The method of claim 11, wherein in the changing of the valid flag of the IPv6 address to 1 and the storing of the changed valid flag in the identification cache table (ICT), the predetermined time has a set value that changes according to a structure of the network.

13. The method of claim 5, wherein before the receiving of the is neighbor solicitation (NS) message that is transmitted from the Request SS through the Request BS so as to resolve the MAC address of the Target SS, a method of generating the Identification Cash Table (ICT) includes:
causing a base station to acquire a MAC address of a subscriber station served by the base station during an initial ranging procedure defined in the IEEE 802.16 based wireless communication system;
causing, when receiving a neighbor solicitation (NS) message for Duplicate Address Detection (DAD) from the subscriber station to which the base station provides a service, the base station to store an address of a target address field of the NS message in an information field of the corresponding subscriber station as an IPv6 address, and set a valid flag of the corresponding IPv6 address to 0; and
changing the valid flag of the IPv6 address to 1 and storing the changed valid flag in the Identification Cache Table (ICT) when the Request BS does not receive a neighbor advertisement (NA) message corresponding to the NS message for a predetermined time after relaying the NS message for the DAD to network.

14. The method of claim 13, wherein in the changing of the valid flag of the IPv6 address to 1 and the storing of the changed valid flag in the identification cache table (ICT), the predetermined time has a set value that changes according to a structure of the network.
